(19) United States
(12) Patent Application Publication
(10) Pub. No.: US 2023/0232789 A1
(43) Pub. Date: Jul. 27, 2023

(54) DOG TRAINING DEVICE

(71) Applicant: Roger Hamamjy, San Jose, CA (US)

(72) Inventor: Roger Hamamjy, San Jose, CA (US)

(21) Appl. No.: 17/586,110

(22) Filed: Jan. 27, 2022

(51) Int. Cl. A01K 15/04; A01K 27/00

(52) U.S. Cl. CPC A01K 15/04; A01K 27/002

(57) ABSTRACT

Various disclosed embodiments include illustrative apparatuses and dog training devices. In an illustrative embodiment, a dog training device includes a harness and a rigid rod. The harness includes a back section, a chest section configured to attach to the back section, and a rod mount configured to attach behind a distal half of the back section. The rigid rod is configured to be received by the rod mount at a first angle relative to the back section to allow the rigid rod to protrude proximally from the harness.

### INTRODUCTION

The statements in this section merely provide background information related to the present disclosure and may not constitute prior art.

Rambunctious, energetic, or alpha-type dogs pull on a traditional leash system (FIG. 1). Current leash systems don't allow the user to properly train their dog to maintain a heel position, thus training them away from alpha-dog issues.

### BRIEF SUMMARY

Various disclosed embodiments include illustrative apparatuses and dog training devices.

In an illustrative embodiment, an apparatus includes a harness for a four-legged animal and a rigid rod. The harness includes a back section having a rod mount, a chest section, and one or more attachment devices configured to attach the back section to the chest section. The rigid rod is configured to be received by the rod mount at a first angle relative to the back section to allow the rigid rod to protrude proximally from the harness.

In another illustrative embodiment, a dog training device includes a harness and a rigid rod. The harness includes a back section, a chest section configured to attach to the back section, and a rod mount configured to attach behind a distal half of the back section. The rigid rod is configured to be received by the rod mount at a first angle relative to the back section to allow the rigid rod to protrude proximally from the harness.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a perspective view of a vehicle with a rear roller door assembly.

FIG. 2 is a perspective view of an overhead door assembly of the rear roller door assembly of FIG. 1.

FIG. 3 is a plan view of a counterbalance assembly included in the overhead door assembly of FIG. 2.

FIG. 4 is a perspective view of the overhead door assembly and vertical tracks of the rear roller door assembly of FIG. 1.

FIG. 5 is a perspective view of components of the rear roller door assembly of FIG. 1.

Like reference symbols in the various drawings generally indicate like elements.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative apparatuses for training an animal

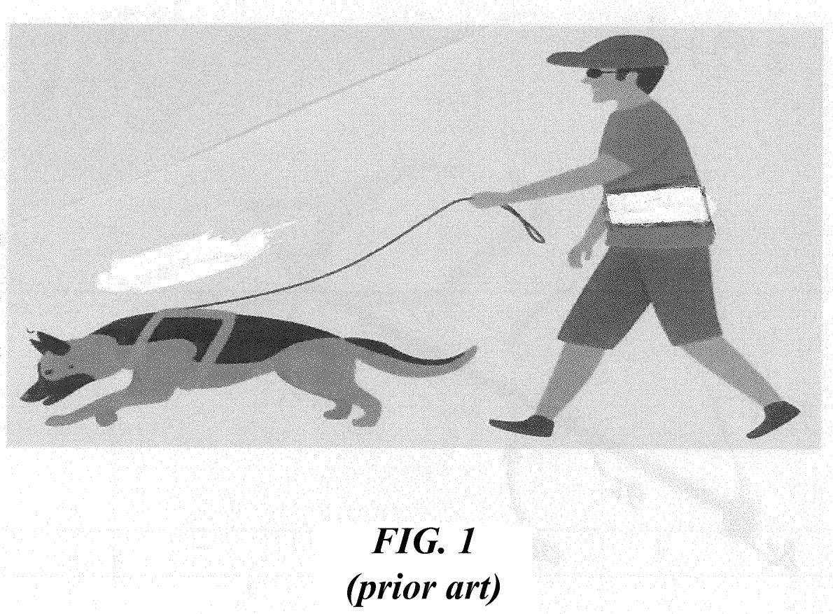

Referring now to FIG. 1, in various embodiments, a training apparatus 20 includes a harness 22 for a four-legged animal, such as, without limitation, a dog. The harness 22 includes a back section 24 having a rod mount 25, a chest section 23, and one or more attachment devices 27 configured to attach the back section 24 to the chest section 23. The training apparatus 20 also includes a rigid rod 26 configured to be received by the rod mount 25 at a first angle 29 from the back section 24 to allow the rigid rod 26 to protrude proximally from the harness 22.

In various embodiments, the rod mount 25 is disposed distally from a midway point of the back section 24. The rod mount 25 may include a rigid receptacle that is configured to releasably attach to a distal end of the rigid rod 26. The rod mount 25 may be made of a metal, rigid plastic, or the like. The rod mount 25 may include features for keeping the rigid rod 26 from rotating. The rod mount 25 is attached to the back section 24, thereby minimizing lateral or longitudinal motion of the rod mount 25 and the rigid rod 26 relative to the back section 24 and the harness 22.

In various embodiments, the one or more attachment devices 27 provide a flexible attachment between the back section 24 and the chest section 23. The attachment devices 27 may be made of an elastic or non-elastic materials. The attachment devices 27 and the and may include back section 24 and/or the chest section 23 may include releasable attachable components, such as, without limitation, hook and loop devices, buttons, snaps, or the like.

In various embodiments, the training apparatus 20 includes a handle 28 located at proximal end of the rigid rod 26. The handle 28 allows a person to resist forward motion of the rigid rod 26 and thus resisting forward motion of a dog and keeping the dog positioned behind the person when walking the dog. A leash 38 is configured to loosely hang between the handle 28 and a collar 32 disposed around a neck of the dog. Because the leash is in the line-of-sight of the dog, the dog gets used to seeing a leash when going on a walk. Thus, once the dog has been trained, not much visually changes for the dog once the apparatus 20 is no longer needed.

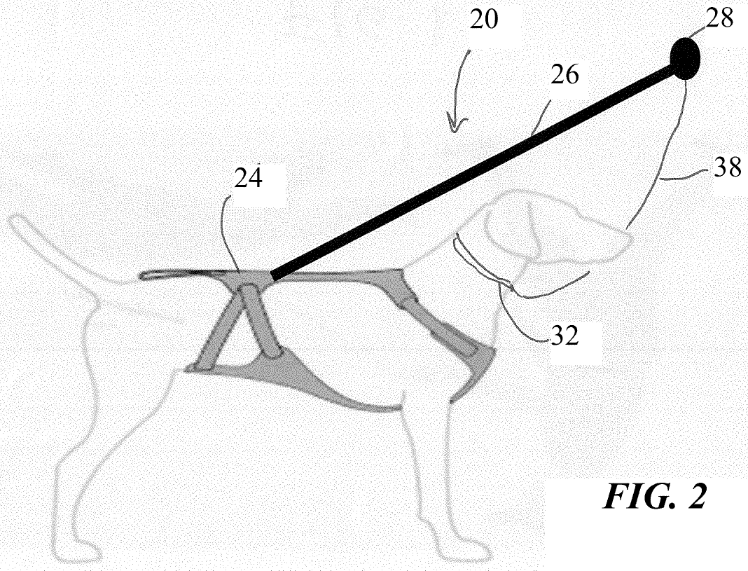

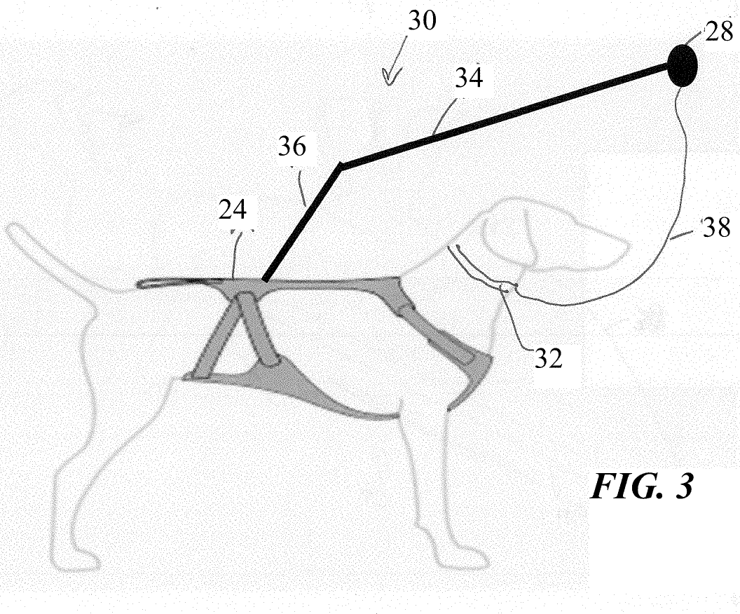

Referring to FIG. 3, a training apparatus 30 includes the harness 22 similar to that shown in FIG. 2. The training apparatus 30 also includes a two-part rigid rod having a distal section 36 configured to attach at a distal end to the rod mount 25 and a proximal section 34 configured to extend from a proximal end of the distal section 36. The distal section 36 extends at a second angle 33 relative to the back section 24. The proximal section 34 extends at a third angle 35 relative to the back section 24. The second angle 33 is greater than the third angle 35.

In various embodiments, the distal section 36 and the proximal section 34 may releasable attach to each other using rod attaching features, such as, without limitation, threaded components, push pins and holes, or the like.

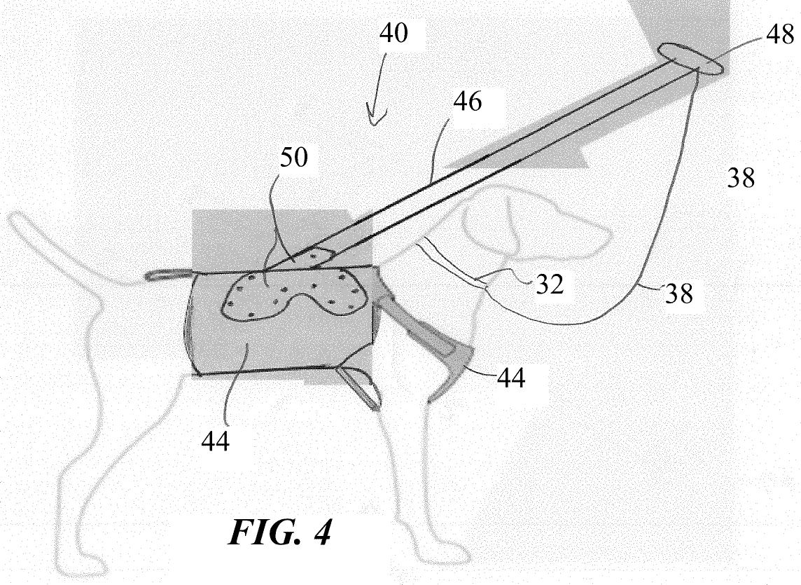

Referring to FIG. 4, a training apparatus 40 includes a harness 44 with a rod mount 50 attached thereto. The harness 44 may be made of any type of conformable material, such as, without limitation, cotton, polyester, or the like. The rod mount 50 includes a rigid or semi-rigid base section 52 that is attached to the harness 44 using any of a variety of attachment devices, such as, without limitation, rivets, threading, or the like. The base section 52 may be curved to conform to the back of the animal The rod mount 50 also includes a rod receiver 54 that protrudes from the base section 52 at a fourth angle 56 relative to the harness 44. The rod receiver 54 and the base section 52 may be formed/machined/molded/printed from a monolithic material, such as, without limitation, thermoplastic, metal, or the like. A rigid rod 46 has a distal end that is configured to be removably received within or over the rod receiver 54 using rod attaching features, such as, without limitation, threaded components, push pins and holes, or the like.

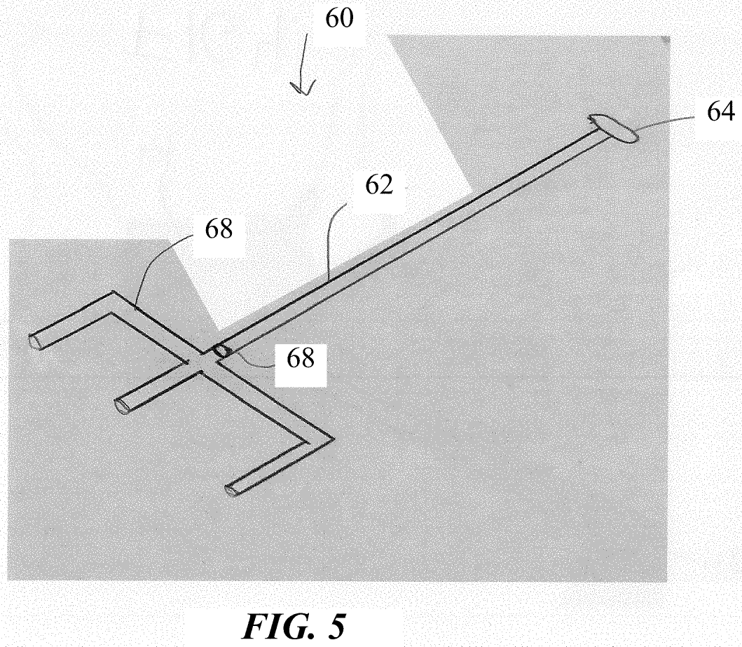

Referring to FIG. 5, in various embodiments, the rigid rods 26, 34, 36, and 46 may be replaced by a multi-dog training rod 60. The multi-dog training rod 60 includes a proximal section 62 with a handle 64 attached to a proximal end of the proximal section 62. The proximal section 62 may be the same as the rigid rods 26, 34, 36, and 46 previously shown. In addition, the multi-dog training rod 60 includes a distal fork section 66 that is releasable attachable to a distal end of the proximal section 62 using rod attaching features 68, such as, without limitation, threaded components, push pins and holes, or the like. Distal ends of the distal fork section 66 are releasable attachable to the rod mount devices shown in any of FIGS. 2-4.

Embodiments:

A. An apparatus comprising: a harness for a four-legged animal, the harness includes: a back section having a rod mount; a chest section; and one or more attachment devices configured to attach the back section to the chest section; and a rigid rod configured to be received by the rod mount at a first angle relative to the back section to allow the rigid rod to protrude proximally from the harness.

B. The apparatus of A, wherein the rod mount is disposed distally from a midway point of the back section.

C. The apparatus of A or B, wherein the one or more attachment devices provide a flexible attachment between the back section and the chest section.

D. The apparatus of any of A-C, further comprising a handle located at proximal end of the rigid rod.

E. The apparatus of D, further comprising a leash configured to loosely hang between the handle and a collar disposed around a neck of the four-legged animal

F. The apparatus of any of A-E, wherein the rigid rod includes: a distal section configured to releasably attach at a distal end to the rod mount; and a proximal section configured to a releasably attach to the distal section at a second angle relative to the back section, wherein the first angle is greater than the second angle.

G. The apparatus of F, wherein at least one of the first angle and the second angle are adjustable.

H. The apparatus of any of A-E, wherein the first angle is adjustable.

I. A dog training device comprising: a harness includes: a back section; a chest section configured to attach to the back section; and a rod mount configured to attach behind a distal half of the back section; and a rigid rod configured to be received by the rod mount at a first angle relative to the back section to allow the rigid rod to protrude proximally from the harness.

J. The device of I, further comprising a handle located at proximal end of the rigid rod.

K. The device of J, further comprising: a collar disposed around a neck of the dog; and a leash configured to loosely hang between the handle and the collar.

L. The device of any of I-K, wherein the rigid rod includes: a distal section configured to releasably attach at a distal end to the rod mount; and a proximal section configured to a releasably attach to the distal section at a second angle relative to the back section, wherein the first angle is greater than the second angle.

M. The device of L, wherein at least one of the first angle and the second angle are adjustable.

N. The device of any of I-K, wherein the first angle is adjustable.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “ a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. An apparatus comprising:
a harness for a four-legged animal, the harness includes:
a back section having a rod mount;
a chest section; and
one or more attachment devices configured to attach the back section to the chest section; and
a rigid rod configured to be received by the rod mount at a first angle relative to the back section to allow the rigid rod to protrude proximally from the harness.

2. The apparatus of claim 1, wherein the rod mount is disposed distally from a midway point of the back section.

3. The apparatus of claim 1, wherein the one or more attachment devices provide a flexible attachment between the back section and the chest section.

4. The apparatus of claim 1, further comprising a handle located at proximal end of the rigid rod.

5. The apparatus of claim 4, further comprising a leash configured to loosely hang between the handle and a collar disposed around a neck of the four-legged animal.

6. The apparatus of claim 1, wherein the rigid rod includes:
a distal section configured to releasably attach at a distal end to the rod mount; and
a proximal section configured to a releasably attach to the distal section at a second angle relative to the back section,
wherein the first angle is greater than the second angle.

7. The apparatus of claim 6, wherein at least one of the first angle and the second angle are adjustable.

8. The apparatus of claim 1, wherein the first angle is adjustable.

9. A dog training device comprising:
a harness includes:
a back section;
a chest section configured to attach to the back section; and
a rod mount configured to attach behind a distal half of the back section; and
a rigid rod configured to be received by the rod mount at a first angle relative to the back section to allow the rigid rod to protrude proximally from the harness.

10. The device of claim 9, further comprising a handle located at proximal end of the rigid rod.

11. The device of claim 10, further comprising:
a collar disposed around a neck of the dog; and
a leash configured to loosely hang between the handle and the collar.

12. The device of claim 9, wherein the rigid rod includes:
a distal section configured to releasably attach at a distal end to the rod mount; and
a proximal section configured to a releasably attach to the distal section at a second angle relative to the back section,
wherein the first angle is greater than the second angle.

13. The device of claim 12, wherein at least one of the first angle and the second angle are adjustable.

14. The device of claim 9, wherein the first angle is adjustable.
